(19) United States
(12) Patent Application Publication
(10) Pub. No.: US 2006/0282659 A1
(43) Pub. Date: Dec. 14, 2006

(54) Communication-network having distributed computing entities

(75) Inventor: Semir Daskapan, Delft (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 11/151,779

(22) Filed: Jun. 13, 2005

(51) Int. Cl. H04L 9/00

(52) U.S. Cl. 713/155

(57) ABSTRACT

The invention relates to a communication-network embodied with distributed computing entities that are interlinked by a wired and/or wireless network, a selection of the computing entities forming a pool of data-sharing entities, one of which entities is appointed a security service distribution-centre for receiving and distributing data within said pool, wherein at least the security service distribution centre shares its security-functionality with at least one of the other computing entities is said pool.

### BACKGROUND OF THE INVENTION

1. Field of the Invention

The present invention relates to a communication-network that is embodied with distributed computing entities such as the network commonly referred to as the internet or the world wide web.

2. Discussion of Related Art

There is a growing tendency of interweaving of infrastructures, making them more complex, less manageable and more vulnerable to random system failures. Critical infrastructures contain some centralized nodes for certain control functions, like a centralized authentication server. An increased threat of sophisticated denial of service attacks (DoS) on those nodes adds to the concern as they exhibit (multiple) single point(s) of failure (MSPF).

To improve dependability and to avoid MSPF, consequently a decentralized structure of replicated servers (as redundants) is usually applied. Redundancy means that (in parallel or serial) similar systems are ready to replace the main system. It is then important to have instant updated redundant systems to minimize the outage (recovery) time. Failures of single systems in decentralized structure, regardless the cause, are considered harmless, since confiscation of one member does not necessarily affect the whole community.

Since redundancy by dedicated hardware is in economical terms considered an indispensable overhead, budgets for such measures are limited. As such the number of replicas and the systems capability to deal with failures, i.e. survivability, is also limited. Ideally however, the security defense system should not be limited in the number of redundants to resist numerous multiple attacks and to achieve perpetual availability of security servers.

### SUMMARY OF INVENTION

One aspect of the invention is to apply resource sharing techniques enabling multiple servers with different purposes and superfluous capacity to share and to increase effectiveness.

A further aspect of the invention is to provide within the given limitations of budget/redundants a complementary security defense system, by which multiple random failures of security centers can be cleared.

A further aspect of the present invention relates to a communication-network embodied with distributed computing entities that are interlinked by a wired and/or wireless network, a selection of the computing entities forming a pool of data-sharing entities, one of which entities is appointed a security service distribution-centre for receiving and distributing data within said pool, wherein at least the security service distribution centre shares its security-functionality with at least two of the other computing entities in said pool.

In still a further aspect of the invention termination of service by the security service distribution centre prompts at least one of the said other computing entities to assume its activity as a next security service distribution centre.

Still another aspect of the invention is that termination of service by the security service distribution centre causes the transmittal of a predefined SOS-message that prompts at least one of the said other computing entities to assume its activity as the next security service distribution centre.

Still another aspect of the invention is directed to the security service distribution centre sharing its security-functionality with a plurality of other computing entities in said pool.

Still another aspect of the invention is directed to the feature that upon termination of service by the security service distribution centre, the plurality of other computing entities collectively decide on the appointment of the next security service distribution centre.

One of the advantageous possibilities to pass on the functionality of the security distribution centre is arrived at by having the security service distribution centre that terminates its service prior thereto appointing the computing entity that assumes activity as the next security service distribution centre.

There are several options to initiate passing on of the activity of the security service distribution centre to another computing entity.

A first option is that termination of service by the security service distribution centre causes it to transmit a predefined SOS-message to the plurality of other computing entities in said pool.

Another option is that each of the plurality of computer entities in said pool regularly checks the activity of the security service distribution centre, and that its not responding initiates the appointment of a next security service distribution centre.

### BRIEF DESCRIPTION OF THE DRAWINGS

FIGS. 1a, b and c show several pools of computing entities each employing a security service distribution centre SDC.

FIG. 2 depicts several pools of computing entities in which the activity of a security service distribution centre passes on to a next computing entity.

### DETAILED DESCRIPTION

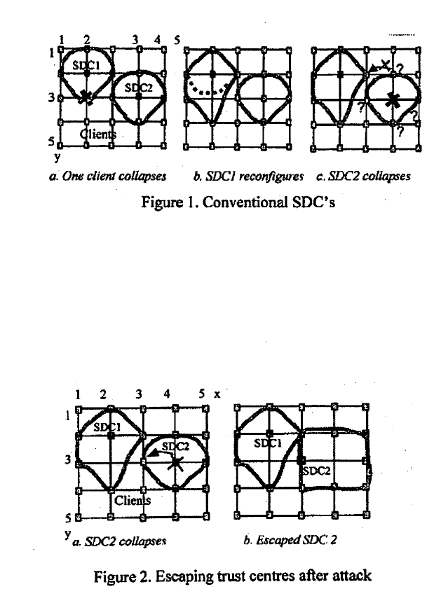

FIGS. 1a, b, and c shows two SDCs' that issue trust, i.e. certificates or keys. Each SDC takes care of the distribution of keys within its own group. If an object wants to communicate with another object, the SDC mediates trust by distributing session keys. In FIG. 1a object (x,y)=(2,3) can start therefore communication with object (3,2) or with an object from another group like (3,3). In the latter one it is required that both SDC's have a trust relationship. In FIG. 1b a situation is depicted in which trust centre (2,2) has formed a new group after a leaving of member (2,3) and new joining members {(1,3);(2,4)}. However when a trust centre like (4,3) collapses then all the group members become useless ‘orphans’ (at least for a certain crucial moment). Any requests for interaction will be rejected, as there is no trust centre to verify their identity and to check permissions. This is depicted in FIG. 1c.

In the next FIG. 2b the trust authority at (4,3) escapes to his neighbor (3,3) and recovers (reincarnates) there, so that the group remains undisturbed after all. By doing so, this mechanism takes care of the reliability and availability of the trust service. The beauty of the invention is that during the security session trust remains centralized, but on attack it distributes and benefits from a decentralized approach as it can practically hop to any collaborating peer.

It is obvious that the larger the network and thus the more collaborating computing entities CE's there are, the principle of self-organization according to the invention can provide perpetual availability of security services by continuously hopping away and reincarnation.

The existing infrastructure components are used more efficiently and intelligently. Efficiently refers to investment costs and availability time: no investment is needed for extra equipment and no time will be lost due to a fatal error of a trust centre for recovery. Intelligently refers to the ability of the individual nodes to distinguish particular information from other nodes and to differentiate in their (re)action. Ultimately this results in a mechanism in which all the entities collaborate to achieve one goal. In this desired situation the grid as a system reacts as a whole to any disturbance of the pool.

In order to effectively let the computing entities of a pool cooperate it is desirable that each critical CE is responsible of regularly cloning and dispatching its process to its neighboring CEs. All the CEs are listening to specific ports for incoming requests of their neighbors, accepting immigrants and preserving (the state of) the received process. Subsequently, they continue listening for a predefined SOS message from their neighbors, which is interpreted as a trigger to activate the preserved guest process from the buffer. This SOS message is generated by an interrupt handler at a certain error event by the failing CE. Besides passively listening, each CE may interrogate (ping) his neighbors to check their viability state. Depending on the SOS message and the viability state, the preserved guest process is either terminated and discarded or continued in execution. Concurrently, the receiving CE is also capable of migrating his own local and the hosted guest processes to other neighbors. Thus, when this receiving CE also starts suffering, it sends an SOS message to the next neighbors and so on.

Although the above example can be usefully applied in the internet environment its scope of application is not restricted thereto. Resource sharing techniques according to the invention enable multiple servers with different purposes, but with superfluous capacity, to share each other's resources in a cluster to achieve economies of scale, and to increase availability. By applying resource sharing in regard of the security function, many not-dedicated systems from the internal business network, but also from other business networks that subscribe, can function as redundants for security systems. When many companies subscribe to this resource sharing service the number of redundants can be very large. As such the number of (DoS) attacks one security system in such a resource sharing cluster can resist is also very large. The invention enables a system administrator to join his security systems with other trusted computer systems, of the same company or of other trusted companies, in one resource sharing cluster. The systems in such cluster collaborate in backing up each other in case one of them suffers from a failure. The destitute computer system is then allowed to continue his security services on one of the other computer platforms.

Since the scope of application of the invention is broad, the above offered example is to be regarded only as a preferred embodiment without however restricting the scope of protection of the appended claims to this specific example.

1. Communication-network embodied with distributed computing entities that are interlinked by a wired and/or wireless network, a selection of the computing entities forming a pool of data-sharing entities, wherein one of which entities is appointed a security service distribution center for receiving and distributing data within said pool, and wherein at least the security service distribution center shares its security-functionality with at least two of the other computing entities in said pool.

2. Communication-network according to claim 1, wherein termination of service by the security service distribution center prompts at least one of the said other computing entities to assume its activity as a next security service distribution center.

3. Communication-network according to claim 2, wherein termination of service by the security service distribution center causes the transmittal of a predefined SOS-message that prompts at least one of the said other computing entities to assume its activity as the next security service distribution center.

4. Communication-network according to claim 1, wherein the security service distribution center shares its security-functionality with a plurality of other computing entities in said pool.

5. Communication-network according to claim 1, wherein upon termination of service by the security service distribution center, the plurality of other computing entities collectively decide on the appointment of the next security service distribution center.

6. Communication-network according to claim 4, wherein the security service distribution center that terminates its service prior thereto appoints the computing entity that assumes activity as the next security service distribution center.

7. Communication-network according to claims 4, wherein termination of service by the security service distribution center causes it to transmit a predefined SOS-message to the plurality of other computing entities in said pool.

8. Communication-network according to claim 4, wherein each of the plurality of computer entities in said pool regularly checks the activity of the security service distribution center.
